(19) United States
(12) Patent Application Publication
(10) Pub. No.: US 2026/0285474 A1
(43) Pub. Date: Sep. 24, 2026

(54) TUNABLE DAMPING UNIT AS A SECONDARY LOAD PATH FOR A MOVABLE ELEMENT WITH ACTUATOR

(71) Applicant: Wisk Aero LLC, Mountain View, CA (US)

(72) Inventors: Andrew Theodore, Huntington Beach, CA (US); Chase Nichols, Kirkland, WA (US)

(73) Assignee: Wisk Aero LLC, Mountain View, CA (US)

(21) Appl. No.: 19/442,707

(22) Filed: Jan. 7, 2026

Related U.S. Application Data
(60) Provisional application No. 63/742,716, filed on Jan. 7, 2025.

(51) Int. Cl. B64C 11/00; B64C 29/00; F16F 9/50

(52) U.S. Cl. CPC B64C 11/008; B64C 29/0033; F16F 9/50

(57) ABSTRACT

Embodiments provide a tunable damping unit coupled to a moveable element. An actuator configured to drive the moveable element provides a primary load path, while the tunable damping unit provides a secondary load path that slows uncontrolled motion of the moveable element in the event of failure of the primary load path. The tunable damping unit can be tuned to a lower damping mode during normal operation to reduce extra loads on the actuator. The tunable damping unit can be quickly tuned to a higher damping mode in case of actuator failure.

### CROSS-REFERENCES TO RELATED APPLICATIONS

This application claims benefit under 35 USC § 119(e) to U.S. Provisional Patent Application No. 63/742,716 filed Jan. 7, 2025, and entitled “Tunable Damping Unit As A Secondary Load Path For A Movable Element With Actuator,” the disclosure of which is incorporated by reference herein in its entirety for all purposes.

### BACKGROUND

A primary load path can be damaged, break, disconnect, or otherwise fail, leaving a movable element in an uncontrolled and unsupported state. To manage failure modes, a secondary load path can be provided for the movable element. However, a secondary load path may undesirably produce added resistance on the primary load path during normal operations or insufficient strength for supporting the moveable element in the case of primary load path failure.

Embodiments address these and other problems, individually or collectively.

### SUMMARY

Embodiments provide a system comprising a movable element configured to move between a first position and a second position; a fixed element; an actuator configured to actuate between an extended position and a retracted position, coupled to the movable element and the fixed element, and configured to move the movable element between the first position and the second position; a tunable damping unit coupled to the movable element and the fixed element, and configured to extend or retract to provide a damping force to the movable element that opposes a motion of the movable element; and a control system configured to control the tunable damping unit, and configured to: operate the tunable damping unit to be set at a first damping mode; and in response to an event, operate the tunable damping unit to be set at a second damping mode.

According to further embodiments, the event is a failure of the actuator, and wherein the control system is further configured to: determine that the actuator has failed.

According to further embodiments, the second damping mode is a higher damping mode that produces greater damping forces than the first damping mode.

According to further embodiments, the event is a first event, and wherein the control system is further configured to: in response to a subsequent event, operate the tunable damping unit to return to the first damping mode.

According to further embodiments, the event is a change in one or more conditions, and further comprising: one or more sensors, wherein the control system is further configured to identify the change in one or more conditions based on information received from the one or more sensors.

According to further embodiments, the change in the one or more conditions includes an increased load on the actuator.

According to further embodiments, the increased load on the actuator is a tension load being applied during actuation.

According to further embodiments, the second damping mode is a higher damping mode that produces greater damping forces than the first damping mode, wherein the damping forces are applied in the same direction as the tension load, and wherein the damping forces cause a reduction in load on the actuator.

According to further embodiments, the increased load on the actuator is a pressure load being applied during actuation.

According to further embodiments, the second damping mode is a lower damping mode that produces lesser damping forces than the first damping mode, wherein the damping forces are applied in the opposite direction as the pressure load, and wherein the damping forces cause an increase in load on the actuator.

According to further embodiments, the increased load on the actuator is caused by vibrations from a high-speed travel.

According to further embodiments, the second damping mode is a higher damping mode that produces greater damping forces than the first damping mode, and wherein the damping forces cause a reduction in load on the actuator.

According to further embodiments, the event is a flight instruction.

According to further embodiments, the flight instruction will cause a change in one or more conditions, and wherein operating the tunable damping unit to be set at the second damping mode occurs before the change in the one or more conditions.

According to further embodiments, the control system is further configured to control the actuator, and configured to: operate the actuator in response to the flight instruction.

According to further embodiments, the first damping mode includes a first viscosity, and the first damping mode includes a second viscosity.

According to further embodiments, the movable element is a tiltable propulsion system, the fixed element a support structure, and further comprising: an aircraft including: a fuselage; a pair of wings coupled to opposite sides the fuselage; the support structure, wherein the support structure is coupled to one of the pair of wings; and the tiltable propulsion system, wherein the tiltable propulsion system is coupled to the support structure, wherein the first position is a vertical flight configuration, and the second position is a forward flight configuration.

Additionally, embodiments provide a method comprising: operating, by a control system, a tunable damping unit to be set to a first damping mode, wherein the tunable damping unit is coupled to a movable element, and the tunable damping unit is configured to provide a damping force to the movable element that opposes a motion of the movable element; detecting, by the control system, an event; and in response to the event, operating, by the control system, the tunable damping unit to be set at a second damping mode.

According to further embodiments, an actuator is coupled to the movable element and configured to provide an actuating force to the movable element that moves the movable element between a first position and a second position.

According to further embodiments, the event is a failure of the actuator, and the second damping mode is a higher damping mode that produces greater damping forces than the first damping mode.

According to further embodiments, the method further comprises: operating, by a control system, the actuator to actuate to move the movable element; and determining, by the control system, a load on the actuator during motion of the movable element; and comparing, by the control system, the load on the actuator to a predetermined threshold value, wherein the event is a load on the actuator exceeding a predetermined threshold during actuation, wherein the damping force applied to the moveable element by the tunable damping unit is in the same direction as the actuating force applied to the moveable element by the actuator, and the second damping mode is a higher damping mode that produces greater damping forces than the first damping mode.

According to further embodiments, the system further include a first coupler providing a first coupling between the actuator and the movable element such that an actuation of the actuator between the extended position and the retracted position causes the motion of the movable element between the first position and the second position; a second coupler providing a second coupling between the actuator and the fixed element; a third coupler providing a third coupling between the tunable damping unit and the movable element such that the motion of the movable element causes extension or retraction of the tunable damping unit; and a fourth coupler providing a fourth coupling between the tunable damping unit and the fixed element.

According to further embodiments, the movable element includes a truss structure, the truss structure including the first coupler and the third coupler, wherein the third coupler is positioned above the first coupler.

According to further embodiments, the actuator is a linear actuator that extends linearly or retracts linearly in response to control signals, and wherein the tunable damping unit is configured to passively extend linearly or retract linearly.

According to further embodiments, the system further include an aircraft, wherein the movable element is a tiltable propulsion system of the aircraft.

Further details regarding embodiments of the invention can be found in the Detailed Description and the Figures.

### BRIEF DESCRIPTION OF THE DRAWINGS

Various embodiments of the invention are disclosed in the following detailed description and the accompanying drawings. In the appended figures, similar components or features may have the same reference label. Further, various components of the same or similar type may be distinguished by following the reference label by a dash and a second label that distinguishes among the similar components.

FIGS. 1A-1B depict planar views an exemplary aircraft with tilting fans in forward and vertical configurations, respectively, according to embodiments.

FIG. 2A illustrates an example of a tilting propulsion system in a vertical flight configuration, according to embodiments.

FIG. 2B illustrates an example of a tilting propulsion system in a first intermediary tilt configuration, according to embodiments.

FIG. 2C illustrates an example of a tilting propulsion system in a second intermediary tilt configuration, according to embodiments.

FIG. 2D illustrates an example of a tilting propulsion system in a forward flight configuration, according to embodiments.

FIG. 3 illustrates an example of a tilting propulsion system with a tunable damping unit and actuator, according to embodiments.

FIG. 4 illustrates a method for controlling a damping mode of a damping unit, according to embodiments.

FIG. 5A illustrates an example of loads experienced by a damping unit during an actuator failure event, according to embodiments.

FIG. 5B illustrates an example of damping unit length as a function of time during an actuator failure event, according to embodiments.

FIG. 6A illustrates an example of loads experienced by a damping unit during an actuator failure event for a damping unit with a relatively higher static damping mode, according to embodiments.

FIG. 6B illustrates an example of loads experienced by a damping unit during an actuator failure event for a damping unit with a relatively lower static damping mode, according to embodiments.

FIG. 6C illustrates an example of loads experienced by a damping unit during an actuator failure event for a tunable damping unit with a modulated damping mode, according to embodiments.

### DETAILED DESCRIPTION

Techniques disclosed herein relate generally to a damping unit providing a backup load path. More specifically, techniques disclosed herein can apply to an aircraft including tiltable propulsion systems. An actuator configured to drive a tiltable propulsion system provides a primary load path, while the damping unit provides a secondary load path. The damping unit can slow uncontrolled motion of the tiltable propulsion system in the event of failure of the primary load path and/or provide support to lessen loads experienced by the primary load path.

According to embodiments, the damping unit can be a tunable damping unit coupled to a moveable element. The tunable damping unit can be tuned to a relatively lower damping mode during normal operation to reduce extra loads on the actuator. The tunable damping unit can be quickly tuned to a higher damping mode in case of actuator failure. Additionally, the tunable damping unit can be tuned to a higher damping mode (e.g., which may still be relatively lower than the damping mode used during a failure event) during normal operation to reduce extra loads on the actuator under certain conditions that cause the actuator and the damping unit to produce force in the same or similar direction.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

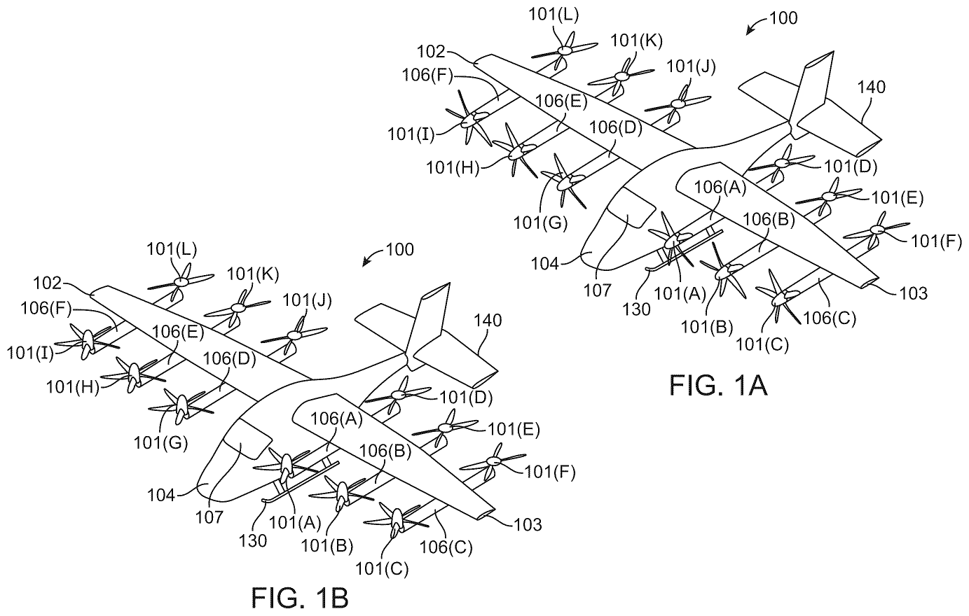

FIGS. 1A and 1B depict planar views of an exemplary aircraft 100, according to embodiments. The aircraft 100 can be any suitable type of flying vehicle, such as an airplane, a helicopter, a drone or a hybrid-type flying vehicle. In some embodiments, the aircraft 100 may be capable of vertical take-off and landing (VTOL). The aircraft 100 can be configured for human piloting, remote piloting, and/or autonomous flight.

In the example shown, aircraft 100 includes a fuselage 104 that may include a cabin section (e.g., toward the nose) for carrying passengers and/or cargo. A pair of wings including a first wing 102 and a second wing 103 can be mounted on or otherwise attached to the fuselage 104. The pair of wings can be coupled to opposite sides of the fuselage, and can take any suitable shape and configuration. For example, the pair of wings can be rectangular straight wings, tapered straight wings, rounded or elliptical straight wings, swept wings, delta wings, or any other suitable type of wing. In some embodiments, the first wing 102 and the second wing 103 may be coupled to the fuselage 104 in a high-wing configuration. That is, the first wing 102 and the second wing 103 may be mounted on an upper portion of the fuselage 104, as shown in FIGS. 1A-1B.

The aircraft 100 can also include support structures 106(A)-(F), which may be coupled to the wings 102, 103. As shown in FIGS. 1A-1B, each of the support structures 106(A)-(F) may take the form of a boom, though embodiments include any other suitable structure. Six support structures 106(A)-(F) are shown in FIGS. 1A-1B, where three support structures 106(A)-(F) are provided under each of the pair of wings 102, 103. The support structures 106(A)-(F) may be coupled to the undersides of the pair of wings, and may include a forward portion extending forward beyond the wing and an aft portion extending aft of the wing.

In some embodiments, each of the support structures 106(A)-(F) are identical, and therefore the support structures 106(A)-(F) may be interchangeable between the positions on the wings. For example, a first support structure 106(A) closer to the fuselage may be interchangeable with an adjacent second support structure 106(B) (e.g., the middle boom on the wing) or a further third support structure 106(C) (e.g., the boom furthest away from the fuselage).

The aircraft 100 can further include landing gear 130. The landing gear 130 can include any suitable combination of one or more skids, wheels, skis, pontoons, shock absorbers, struts, and/or any other suitable component for supporting the aircraft 100 when landing and/or landed on the ground. In some embodiments, the landing gear 130 can be retractable into a compartment within the fuselage 104.

The aircraft 100 can include any\suitable control structures and control surfaces. Any suitable number of ailerons, rudders, elevators, slats, flaps, spoilers, and/or stabilizers can be included. For example, a horizontal stabilizer 140 (e.g., a tailplane) can be coupled to a rear end or tail of the fuselage 104. The horizontal stabilizer 140 may be in any suitable shape or form. For example, as shown in FIGS. 1A-1B, the horizontal stabilizer 140 may include two stabilizer surfaces protruding at horizontally from a tail. In some embodiments, each of the stabilizer surfaces can further include hinged control surfaces on the aft edges. Additionally, as shown in FIGS. 1A-1B, an additional (e.g., third) vertical stabilizer surface can be mounted on the tail, extending vertically upward and/or downward. Introducing the horizontal stabilizer 140 can provide additional stability and control of the aircraft 100. This can be especially useful during times when vertical fans are disabled or otherwise not being utilized or relied on for control and stability (e.g., during cruising flight).

### Propulsion Systems

The aircraft 100 can also include propulsion systems 101(A)-(L). While twelve propulsion systems 101(A)-(L) are shown in FIGS. 1A-1B, any suitable number of propulsion systems 101(A)-(L) can be included. The propulsion systems 101(A)-(L) may be coupled to the pair of wings 102, 103, and may be divided equally between the wings. In some embodiments, as shown in FIGS. 1A-1B, one or more of the propulsion systems 101(A)-(L) may be mounted on the support structures 106(A)-(F). For example, pairs of propulsion systems 101(A)-(L) may be mounted on opposite ends of a respective support structure 106(A)-(F), with one propulsion system mounted forward of the wing and another propulsion system mounted aft of the wing. In other embodiments, one or more of the propulsion systems 101(A)-(L) may be coupled directly to the wings. The number of booms and/or propulsion systems may vary according to the flight needs and requirements of the aircraft 100.

According to various embodiments, each of the propulsion systems 101(A)-(L) may be configured to provide thrust to the aircraft 100. The thrust from one or more of the propulsion systems 101(A)-(L) can be used to move, control, and/or stabilize the aircraft 100. The propulsion systems 101(A)-(L) can take the form of any suitable mechanism for providing thrust. In one example, a propulsion system may include a rotor (e.g., a fan). A propulsion system can also include a drive mechanism for the rotor, such as a dedicated electric motor (e.g., in the case of electric vehicles).

A rotor may comprise any suitable number of rotor blades (e.g., 2 blades, 3 blades, 4 blades, 5 blades, 6 blades, 7 blades, or 8 blades). The rotor blades may be spaced equally or unequally. The rotor may further comprise a hub. The rotor blades may be attached to the hub. In some embodiments, the rotor blades and an integral hub may be manufactured as a single piece. The hub provides a central structure to which the rotor blades connect, and in some embodiments is made in a shape that envelops the motor.

The rotor blades may have a predetermined pitch or a predetermined angle of attack. In some embodiments, all rotor blades may have the same pitch or the same angle of attack. In other embodiments, at least two rotor blades may have different pitches or angles of attack than each other.

In some embodiments, one or more rotor blades of a propulsion system may have adjustable pitch settings (also referred to as variable pitch positions). Such a propulsion system may be referred to as a variable pitch propeller. In a variable pitch propeller, the blade pitch of one or more rotor blades may be adjusted during flight. The blade pitch can thus be adjusted to optimize for thrust and/or efficiency based on a phase of flight, such as takeoff, climb or cruise. For example, a fine pitch setting, which may provide greater thrust, may be used during take-off, acceleration, gaining altitude, and/or landing. A coarser pitch, which may provide better efficiency, may be used for high-speed cruise flight. An example of a low pitch used during take-off is about 15 degrees. An example of a high pitch used during cruise flight is about 40 degrees.

The amount of thrust produced by a rotor blade is dependent on the speed and the angle of attack of the rotor blade. The effective angle of attack of the rotor blade may decrease as airspeed increases. To maintain a constant effective angle of attack or otherwise optimum effective angle of attack, the blade pitch may be increased.

In some embodiments the motor parts are low-profile so that the entire motor fits within the hub of the rotor, presenting lower resistance to the air flow when flying forward. The rotor can be attached to the rotating part of the motor. The stationary part of the motor can be attached to a support structure. In some embodiments the motor can be a permanent magnet motor and can be controlled by an electronic motor controller. The electronic motor controller can send electrical currents to the motor in a precise sequence to allow the rotor to turn at a desired speed or with a desired torque.

According to various embodiments, the aircraft 100 may be an electrically powered aircraft or a hybrid-electric aircraft. One or more battery units may be included in the aircraft 100 (e.g., within the fuselage 104) and configured to provide power to various aircraft components, such as one or more electric motors and/or on-board computer systems. The propulsion systems 101(A)-(L) may be driven by electric motors that are powered by an electric power system including the one or more battery units. In some embodiments, each of the propulsion systems 101(A)-(L) may be coupled to a dedicated battery unit. Alternatively, there may be a one-to-many relationship between the one or more battery units and the propulsion systems 101(A)-(L). In some cases, one or more battery units may be the sole power source for the aircraft 100. Each battery unit may include one or more battery cells.

### Propulsion System Orientation—Vertical

According to various embodiments, one or more of the propulsion systems 101(A)-(L) may be positioned, oriented, and/or otherwise configured to provide thrust and/or movement to the aircraft 100 in a predefined direction. For example, one or more of the propulsion systems 101(A)-(L) may be configured to provide thrust upward in a vertical direction. As shown in FIG. 1A, these can include propulsion systems 101(D), 101(E), 101(F), 101(J), 101(K), and/or 101(L). Propulsion systems that are configured to provide thrust in a vertical direction may also be referred to as vertical fans or lift fans, or may be referred to as propulsion systems having a lift orientation or a hover orientation. Vertical fans may be used to generate vertical thrust (e.g., lift) for taking off, landing, hovering, stabilizing, and/or controlling the aircraft 100.

A vertical direction may be defined relative to the body of the aircraft 100. For example, a vertical direction can be the aircraft's vertical axis or z-axis (e.g., the plumb line that intersects the zenith and is orthogonal to the ground when the aircraft 100 is on the ground at rest, or hovering just above the ground). In some embodiments, the vertical direction may be orthogonal to the ground when the aircraft 100 is on the ground at rest and/or in a stable hover just above the ground in a level orientation. If the aircraft 100 is tilted, the aircraft's z-axis (and the vertical direction) may no longer be orthogonal to the ground. Vertical thrust may be thrust in a vertical direction (e.g., up or down).

Vertical thrust can be achieved by installing the vertical fans and/or their corresponding support structures 106(A)-(F) so that the rotational axis of each of the vertical fans is parallel with the vertical direction and/or orthogonal to a direction of forward flight. In other words, the vertical fans may be oriented such that their rotor blades rotate within a horizontal plane (e.g., a plane that is horizontal relative to the fuselage, or a plane defined by the x-axis and y-axis of the aircraft 100) and about the vertical axis (e.g., the z-axis of the aircraft 100). In some embodiments, the vertical fans may be configured so that each set of rotor blades rotate within the same plane. In other embodiments, the vertical fans may be configured so that one or more of the sets of rotor blades rotate within different planes (e.g., parallel planes).

In other embodiments, some or all of the vertical fans are oriented at an angle, so that on an individual level, one or more vertical fans have rotor blades that do not rotate within a horizontal plane, and do not provide thrust that is completely vertical, but instead provide thrust in a direction that is angled relative to vertical. However, in combination, a set of angled vertical fans can together provide a net thrust in the vertical direction. For example, a non-vertical thrust component provided by an angled vertical fan on the first wing 102 can be counteracted by an equal and opposite non-vertical thrust component provided by an oppositely angled vertical fan on the second wing 103.

In some embodiments, two adjacent vertical fans may have their blades mounted with opposite angles of attack such that their rotor blades spin in opposite directions. Adjacent vertical fans may refer to two vertical fans (e.g., 101A and 101D) that are coupled to opposite ends of the same support structure 106(A), or two vertical fans (e.g., 101A and 101B) that are on different support structures, or two vertical fans (e.g., 101A and 101G) that are on different wings.

According to various embodiments, a first subset of vertical fans may spin in a first direction, and a second subset (e.g., remainder) of vertical fans may spin in a second direction, opposite to the first direction. Configuring the vertical fans so that some spin in a first direction and other spin in an opposite second direction can advantageously cancel out any angular momentum created by the spinning blades so that the aircraft 100 can hover in a stable manner without rotating.

Further, rotational movement about the vertical axis of the aircraft 100 (e.g., yaw) can be performed when desired by temporarily reducing the spin rotational rate of some or all a first subset of vertical fans spinning in a first direction, and/or by temporarily increasing the spin rotational rate of a second subset of the vertical fans spinning in a second direction so that the total angular momentum created by the spinning blades does not cancel out. Accordingly, the aircraft 100 can rotate with the use of vertical fans without needing another source of thrust oriented in another direction.

### Propulsion System Orientation—Horizontal

According to various embodiments, one or more of the propulsion systems 101(A)-(L) may be configured to provide thrust forward in a horizontal direction. As shown in FIG. 1A, these can include propulsion systems 101(A), 101(B), 101(C), 101(G), 101(H) and/or 101(I). Propulsion systems that are configured to provide thrust in a horizontal direction may also be referred to as horizontal fans or propellers, or may be referred to as propulsion systems having a forward flight orientation. Horizontal fans may be used to provide horizontal thrust for forward flight, climb, descent, and/or cruise. As shown in FIGS. 1A-1B, two propulsion systems of the same type (e.g., two vertical fans) or of different types (e.g., one vertical fan and one horizontal fan) can be mounted on each of the support structures 106(A)-(F).

A horizontal direction may be defined relative to the body of the aircraft 100. For example, a horizontal direction can be the aircraft's forward axis or x-axis. In some embodiments, the horizontal direction may be parallel to the ground when the aircraft 100 is on the ground at rest, in a stable hover just above the ground in a level orientation, and/or in a forward flight condition. If the aircraft 100 is tilted, the aircraft's x-axis (and the horizontal direction) may no longer be parallel to the ground. Horizontal thrust may be thrust in a horizontal direction (e.g., forward or backward).

Horizontal thrust (e.g., forward thrust) can be achieved by installing the horizontal fans and/or their corresponding support structures 106(A)-(F) so that the rotational axis of each of the horizontal fans is parallel with the horizontal direction and/or parallel to a direction of forward flight. In other words, the horizontal fans may be oriented such that their rotor blades rotate within a vertical plane (e.g., a plane defined by the z-axis and y-axis of the aircraft 100) and about the forward axis (e.g., the x-axis of the aircraft 100). In some embodiments, the horizontal fans may be configured so that each set of rotor blades rotate within the same plane. In other embodiments, the horizontal fans may be configured so that one or more of the sets of rotor blades rotate within different parallel planes.

In some embodiments, the horizontal fans may be configured to have the capability of spinning in either direction. As a result, the horizontal fans may be able provide a reverse thrust. A reverse thrust can be useful for moving the aircraft 100 in a backward direction (e.g., backing out of a hangar area from a hover position). Additionally, a reverse thrust can be used to reduce forward flight velocity. For example, reverse thrust from the horizontal fans can be used in instead of, or in addition to, flaps to slow the aircraft 100 and/or bring the aircraft 100 to a stationary hover.

In some embodiments, the horizontal direction and the vertical direction may be orthogonal to one another. Accordingly, vertical fans and horizontal fans may provide thrust in substantially orthogonal directions. In other embodiments, the vertical fans and horizontal fans may provide thrust that is about orthogonal or nearly orthogonal, but not exactly orthogonal. Isolating the directional thrusts into two separate types of components can beneficially simplify the control and design of the aircraft 100. In some embodiments, the horizontal fans and the vertical fans can be operated, powered on, and otherwise controlled independently from one another, thereby allowing thrust to be applied independently in the orthogonal directions (e.g., thrust can be applied in the different directions at the same time and at different times).

A combination of the horizontal fans and wings 102, 103 may achieve both forward movement and lift. In some embodiments, it may be more efficient to utilize the horizontal fans and wings 102, 103 to achieve vertical lift, instead of the vertical fans. Once the aircraft 100 reaches a sufficient speed (e.g., predetermined amount of speed, or a cruising speed) so that the wings provide sufficient lift to the aircraft 100, the vertical fans may no longer be needed to provide lift, and the vertical fans may temporarily stop operating. For example, the vertical fans may initially be active and generate vertical thrust to lift the aircraft 100. Once the aircraft 100 is off the ground and/or at a certain height, the horizontal fans can activate and/or increase the horizontal thrust so that the aircraft 100 gains horizontal velocity. The vertical fans may continue providing vertical lift while horizontal velocity increases, as the wings 102, 103 may not provide sufficient vertical lift until a predetermined speed (e.g., a cruising speed) is achieved. The vertical fans may eventually (or gradually) reduce their vertical thrust contribution as the wings 102, 103 gradually provide more (e.g., an increasing amount of) vertical lift during the increasing horizontal velocity. Later on, as the aircraft 100 slows or returns to a hover position, the vertical fans can reactivate and/or increase vertical thrust.

### Propulsion System Orientation—Fixed

According to various embodiments, one or more of the propulsion systems 101(A)-(L) may have a fixed orientation. For example, one or more of the propulsion systems 101(A)-(L) may be mounted in a fixed orientation relative to a respective wing 102 or 103, a respective support structure 106(A)-(F), and/or the aircraft 100. While the rotor blades of a fixed propulsion system can rotate when activated, the orientation of the propulsion system housing and structure may not be rotatable with respect to the aircraft 100. As a result, a fixed propulsion system can be configured to provide thrust in a constant direction relative to the aircraft 100. The thrust direction and orientation of a fixed propulsion system relative to the aircraft 100 (e.g., the fuselage, wings, and/or support structures) may not change or move, regardless of the current activities of the aircraft 100 and/or direction of movement (e.g., both forward flight and vertical flight), according to embodiments.

In some embodiments, one or more vertical fans may have fixed orientations. For example, one or more of propulsion systems 101(D), 101(E), 101(F), 101(J), 101(K), and/or 101(L) may have fixed vertical orientations. These may be referred to as fixed vertical fans.

Further, according to some embodiments, one or more of the horizontal fans may have fixed orientations. For example, propulsion systems 101(A), 101(B), 101(C), 101(G), 101(H) and/or 101(I) may have fixed horizontal orientations. These may be referred to as fixed horizontal fans.

In some embodiments, all of the propulsion systems 101(A)-(L) may have fixed orientations. As a result, the vertical fans and the horizontal fans may be permanently configured to provide thrust in orthogonal (or substantially orthogonal) directions.

### Propulsion System Orientation—Tiltable

In other embodiments, one or more of the propulsion systems 101(A)-(L) may be configured to change orientation. For example, one or more of the propulsion systems 101(A)-(L) may be configured and/or mounted in a manner that allows the angle and orientation to be tiltable relative to a respective wing 102 or 103, a respective support structure 106(A)-(F), and/or the aircraft 100. As a result, a tilting propulsion system, which may also be referred to as a tiltable propulsion system or a tilting fan, can be configured to provide thrust in more than one direction relative to the aircraft 100.

As discussed above, propulsion systems 101(A), 101(B), 101(C), 101(G), 101(H) and/or 101(I) may take the form of fixed horizontal fans. However, in other embodiments, one or more of propulsion systems 101(A), 101(B), 101(C), 101(G), 101(H) and/or 101(I) may instead take the form of tilting fans. Such tilting fans may be configured to switch (e.g., rotate or tilt) between a horizontal orientation and a vertical orientation. Horizontal orientation can also be referred to as horizontal direction, forward flight configuration, second tilt configuration, a second position, and/or second tilt angle. Vertical orientation can also be referred to as vertical direction, vertical flight configuration, first tilt configuration, a first position, and/or first tilt angle. FIG. 1A illustrates the tilting fans as currently set to a forward flight configuration (also referred to as a second tilt configuration or a second tilt angle). FIG. 1B illustrates the tilting fans as currently set to a vertical flight configuration (also referred to as a first tilt configuration or first tilt angle).

As shown in FIG. 1B, all of the propulsion systems 101(A)-(L) may have a vertical orientation. Some of these may be vertical fans with a fixed vertical orientation (e.g., propulsion systems in the back row locations at 101(D), 101(E), 101(F), 101(J), 101(K), and/or 101(L)), while others may be tilting fans that are currently and temporarily set to have a vertical orientation or a vertical flight configuration (e.g., propulsion systems in the front row locations at 101(A), 101(B), 101(C), 101(G), 101(H) and/or 101(I)). The tilting fans may have an orientation that is the same as or similar to that of the vertical fans. FIG. 1A illustrates the tilting fans (e.g., propulsion systems in the front row locations at 101(A), 101(B), 101(C), 101(G), 101(H) and/or 101(I)) in a forward flight configuration.

Embodiments allow the aircraft 100 to include any suitable combination and number of tilting fans, fixed horizontal fans, and/or fixed vertical fans. Also, each type of fan can be located at any suitable position along the wings 102, 103 and/or at any suitable support structure 106(A)-(F). The type of propulsion system at each location may be selected to enhance any number of flight characteristics including forward thrust, vertical thrust, maneuverability, drag, and/or any suitable flight characteristic.

While tilting fans can provide the ability to increase thrust in a specific direction as desired, it can be beneficial to incorporate one or more propulsion systems with fixed orientations in order to reduce weight, reduce moving parts, reduce possible failure points, and/or reduce maintenance concerns.

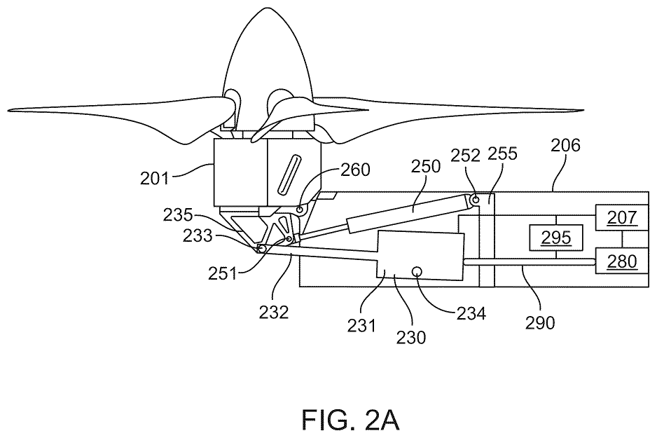

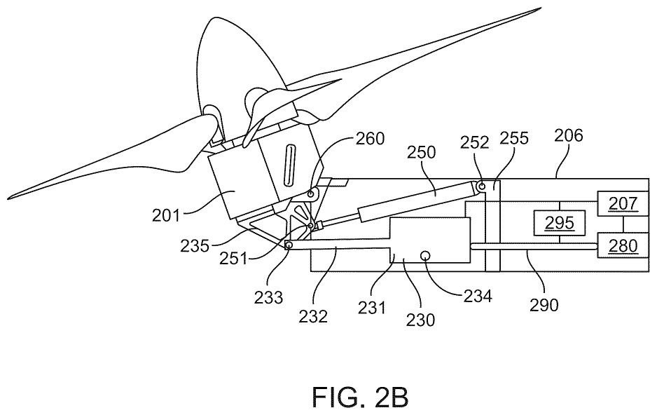

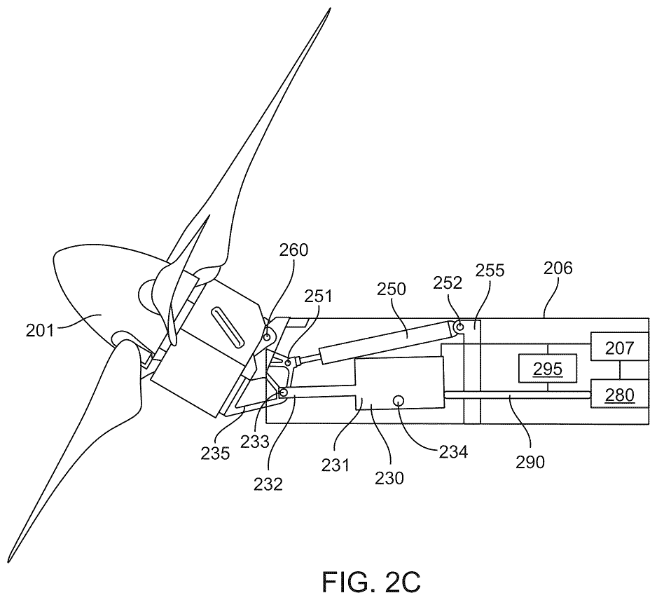

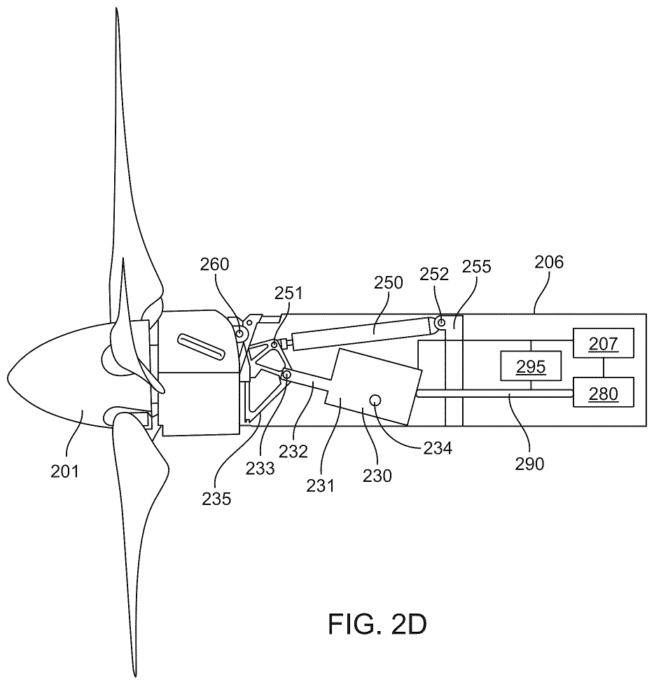

FIGS. 2A-2D illustrate an example of a propulsion system 201 that is configured to tilt. One or more of the propulsion systems 101(A)-(L) of FIGS. 1A-1B can take the form of the propulsion system 201 illustrated in FIGS. 2A-2D. The propulsion system 201 (also referred to as a tilting fan) may be configured to tilt through a predefined range of tilt configurations. The tilt configurations can include a vertical flight configuration (e.g., 90 degrees, or about 90 degrees) as illustrated in FIG. 2A, a forward flight configuration (e.g., 0 degrees, or about 0 degrees) as illustrated in FIG. 2D, and/or any other suitable number of intermediary tilt configurations between the vertical flight configuration and the forward flight configuration, such as a first intermediary tilt configuration as illustrated in FIG. 2B and a second intermediary tilt configuration as illustrated in FIG. 2C.

The propulsion system 201 can be controlled to switch between the tilt configurations to provide additional thrust in any suitable direction, depending on current movement needs of aircraft. For example, during takeoff, landing, and/or hovering, the propulsion system 201 may be set to the vertical flight configuration to provide additional vertical thrust. During forward cruising flight, the propulsion system 201 may be set to the forward flight configuration to provide horizontal thrust. During stages of forward acceleration, deceleration, altitude gaining, and/or altitude decreasing, the propulsion system 201 may be set to an intermediary tilt angle and configuration to provide both a horizontal thrust component and a vertical thrust component.

According to embodiments, the propulsion system 201 may be gradually tilted, iteratively tilted, or otherwise pass through multiple different intermediary tilt angles based on the stage of flight and/or aircraft needs. For example, during forward acceleration and/or an altitude gaining stage of flight, the propulsion system 201 can gradually tilt (e.g., 0.5 degrees at a time, 1 degree at a time, etc.) from vertical toward horizontal as speed is gained and/or altitude is gained.

In some embodiments, the vertical flight configuration may be a maximum tilt, and the forward flight configuration may be a minimum tilt of the propulsion system 201. In other embodiments, the propulsion system 201 may be capable of tilt angles and configurations beyond the vertical flight configuration (e.g., angled past vertical so that there is a reverse horizontal component) and/or tilt angles and configurations lower than the forward flight configuration (e.g., angled below horizontal so that there is a downward component).

### Tilting Mechanism

A tilting mechanism can be configured to cause the propulsion system 201 to tilt. A tilting mechanism can include one or more controllable components that are coupled to the propulsion system 201 and/or a support structure 206, which can thereby enable relative position and angle changes between the propulsion system 201 and the support structure 206, according to embodiments. The support structure 206 can also be referred to as a fixed element. The propulsion system 201 can be referred to as a movable element, as it may move relative to the fixed element. According to embodiments, the motion may be a tilting motion. As illustrated in FIGS. 2A-2D, the tilting mechanism can include an actuator 230, a revolute joint 260, and/or any other suitable components. The tilting mechanism 220 shown in FIGS. 2A-2D is for exemplary purposes, and embodiments allow any other suitable tilting mechanism components and configurations.

The revolute joint 260 can include a rotatable coupling between the propulsion system 201 and the support structure 206. The revolute joint 260, also referred to as a hinge or a pin joint, can include a pin, bolt, a rotary bearing, and/or any other suitable components.

The actuator 230 can be any suitable device configured to cause motion. According to embodiments, any suitable type of actuator 230 can be utilized for causing motion (e.g., tilting motion) at the propulsion system 201. For example, the actuator 230 can take the form of a linear actuator. A linear actuator can include any suitable device configured to cause linear motion. A linear actuator can be configured to convert rotary motion (e.g., from a rotating rotor and/or gears) into linear motion (e.g., of a rod or shaft). A linear actuator may be a 2-force member actuator, providing force along an axis in either direction. Examples of linear actuators include ball screws, cam actuators, wheel and handle actuators, and the like.

The actuator 230 can be coupled to the propulsion system 201. For example, the propulsion system 201 can include a truss structure 235, and the actuator 230 can be coupled to the truss structure 235. In some embodiments, the truss structure 235 can include a rigid framework. For example, the truss structure 235 can include an assembly of members (e.g., beams or other structural components) connected by nodes (e.g., joints), together forming the rigid framework. The members can be two-force members, and the members can be organized so that the assemblage as a whole behaves as a single object.

Embodiments include any suitable coupling between the actuator 230 and the propulsion system 201. In some embodiments, a first coupler 233 can couple the actuator 230 to the truss structure 235 of the propulsion system 201. The first coupler 233 can include one or more of a pin, bolt, spherical joint, trunnion joint, fixed bracket, pivot bracket, shackle, gimble, and/or any other suitable structural coupling and/or mounting mechanisms. In some embodiments, the first coupler 233 can incorporated into the truss structure 235 and/or otherwise a part of the truss structure 235.

The actuator 230 can also be coupled to the support structure 206. According to embodiments, a second coupler 234 can couple the actuator 230 to the support structure 206. The second coupler 234 can include one or more of a pin, bolt, spherical joint, trunnion joint, fixed bracket, pivot bracket, shackle, gimble, and/or any other suitable structural coupling and/or mounting mechanisms.

According to embodiments, the support structure 206 may surround the actuator 230. The support structure 206 can be a hollow structure partially enclosing the actuator 230. In the illustrations in FIGS. 2A-2D, a portion of the support structure 206 is not shown in order to reveal internal components (e.g., the actuator 230 and damping unit 250) disposed within the support structure 206.

According to some embodiments, the actuator 230 can include a translating component 232 and an actuating component 231.

The actuating component 231 can take the form of a motor, one or more gears (e.g., a gear box), and/or an engaging component, according to some embodiments. The motor can be an electric motor, which can include a stator and a rotor. The rotor can be coupled to and cause rotation of the one or more gears. The one or more gears can be coupled to the engaging component, which can include a drive nut, slide block, ball nut, lead nut, or the like. The engaging component can engage to the translating component 232, and cause the translating component 232 to move. In some embodiments, the engaging component can include ball bearings that recirculate on an internal track. Embodiments allow the actuator 230 to include a local power source (e.g., a battery), and/or be connected to a separate aircraft power source (e.g., a battery). Additionally, embodiments allow the actuating component 231 to instead include other suitable source of power and/or motion, such as a hydraulic system.

The translating component 232 can be configured to move (e.g., extend or retract linearly) when actuated by the actuating component 231. The translating component 232 can take the form of a rod, shaft, lead screw, or any other suitable elongated object. The translating component 232 can be threaded or include ball grooves. The translating component 232 can be extendable (e.g., a “slider” configured for telescoping movement), and can thereby provide an extendable, retractable, and/or otherwise dynamic and adjustable coupling between the propulsion system 201 and the support structure 206. As the translating component 232 extends toward an extended position and retracts toward a retracted position, the propulsion system 201 can rotate about the revolute joint 260. Thereby, the propulsion system 201 is put into motion and the tilt configuration of the propulsion system 201 changes. For example, extension of the translating component 232 toward an extended position can cause the propulsion system 201 to move (e.g., tilt) upward toward a vertical flight configuration. Retraction of the translating component 232 toward a retracted position can cause the propulsion system 201 to tilt downward toward a forward flight configuration. Accordingly, the actuator 230 can be configured to provide linear motion that is converted into or otherwise causes rotary motion at the propulsion system 201.

As mentioned above, the actuator 230 (e.g., the translating component 232 of the actuator 230) can be configured to actuate linearly relative to its own structural body. Further, due to the coupling to the propulsion system 201, the actuator 230 may experience a pivoting or rotational motion as a result of the linear actuation. As illustrated in FIGS. 2A-2D, as the propulsion system 201 tilts, the first coupler 233 may move with the propulsion system 201, and the actuator 230 may be caused to pivot due to the first coupler 233 moving while the second coupler 234 maintains a fixed position on the support structure 206. The actuator 230 may pivot about an axis (referred to as a first axis) located at the second coupler 234.

A power source 280 can be configured to provide power to the propulsion system 201 and/or the actuator 230. The power source 280 can include one or more battery units and/or any other suitable source of power, according to embodiments. The power source 280 can represent a dedicated power source for the propulsion system 201 and/or actuator 230, or a shared power source for multiple components of the aircraft or the entire aircraft.

The load measurement device 295 can be configured to measure one or more parameters associated with the load on the actuator 230. In some embodiments, the load measurement device 295 may not directly measure the load on the actuator 230, but the load on the actuator 230 may be determinable based on one or more parameters measured by load measurement device 295. For example, to actuate and cause tilting motion, the actuator 230 may draw power from the power source 280 via a power distribution line 290. The load measurement device 295 may be configured to determine the amount and/or rate of power being drawn from the power source 280 by the actuator 230. The amount of power can then be used to calculate the load on the actuator 230.

As an example, the load measurement device 295 can take the form of a current meter. The current meter can determine an amount of electrical current being drawn from the power source 280 by measuring the electrical current in the power distribution line 290, or at any other suitable location. A measured amount of electrical current (e.g., in Amps) can be used to determine an amount of power being drawn from the power source 280 and/or an amount of force (e.g., in Newtons) being exerted by the actuator 230. For example, the control system 207 may store information about a known ratio of force exerted by the actuator 230 per electrical power drawn from the power source 280 (e.g., based on a known gear ratio and torque constant of the actuator 230).

Embodiments include other types of load measurement devices. For example, the load measurement device 295 can alternatively take the form of a load sensor, a pressure sensor, strain gauge, or other force sensor at the actuator 230, a remaining energy meter at the power source (e.g. to determine total amount of power used during a complete tilting motion), a voltage meter, etc. The load measurement device 295 can be in any suitable location and/or integrated into any suitable component. For example, embodiments allow the load measurement device 295 to be integrated into the actuator 230, the power source 280, and/or the control system 207.

As shown by the connecting communication lines in FIGS. 2A-2D, the control system 207 may be in operative communication with one or more of the power source 280, the load measurement device 295, the actuator 230, and/or any other suitable components. While these elements are illustrated as being positioned within the support structure 206, one or more of the control system 207, the power source 280, and/or the load measurement device 295 may be located elsewhere on the aircraft.

### Control System

The control system 207 illustrated in FIGS. 2A-2D, which may be the same as or similar to the control system 107 illustrated in FIGS. 1A-1B, may be configured to control the propulsion system 201 and/or the aircraft 100. The control system 207 may be configurable to control the aircraft automatically and/or remotely (e.g., via a control signal received from a remote entity, such as a remote controller, a remote pilot or a remote-control tower). In various embodiments, the control system 207 can include one or more computers with one or more non-transitory computer readable medium storing instructions, and one or more processors configured to execute the instructions in order to perform the processing and control functions described herein.

For example, the control system 207 may control when the propulsion system 201 (and/or other propulsion systems of the aircraft) should be operated, and/or the amount of power provided to the propulsion system 201. The control system 207 may be configurable to control the propulsion system 201 independently from other propulsion systems. According to various embodiments, the control system 207 may control the propulsion system 201 based on input received from a remote controller (e.g. remote pilot), input received from an autopilot, sensor data and/or flight data received from the sensors (e.g. sensors measuring air temperature, electric motor temperature, airspeed of the aircraft, etc.), computers, and other input/output devices coupled to the aircraft.

The control system 207 may also control a tilting mechanisms to switch the positioning of a tilting fan from the forward flight configuration to the vertical flight configuration, from the vertical flight configuration to the forward flight configuration, to one or more intermediary tilt angles, and/or to sweep through a range of tilt angles according to a flight plan or as needed. For example, the control system 207 be in communication with and in control of the actuator 230 configured to cause tilting for the propulsion system 201. As a result, the control system 207 can control the tilt configuration of the propulsion system 201 through the actuator 230. According to various embodiments, the control system 207 (e.g., flight control system) may control the tilt angles of the tilting fan based on sensor data and/or flight data received from the sensors (e.g., sensor measuring air temperature, electric motor temperature, airspeed of the aircraft, etc.), computers, and other input/output devices coupled to the aircraft.

Accordingly, the control system 207 may be configured to translate pilot or other operator input, and/or corrections computed by an onboard computer, into forces and moments and/or to further translate such forces and moments into a set of actuator (e.g., vertical lift rotors; propellers; control surfaces, such as ailerons; etc.) and/or associated parameters (e.g., lift fan power, tilt angle, rotor blade pitch, speed, or torque) to provide the required forces and moments. For example, pilot or other operator inputs may indicate a desired change in the aircraft's speed, direction, and/or orientation, and/or wind or other forces may act on the aircraft, requiring the propulsion systems and/or other actuators to be used to maintain a desired aircraft altitude (roll/pitch/yaw), speed, and/or altitude.

According to various embodiments, the control system 207 may be configurable to receive a flight instruction, such as a takeoff, hover, cruise, or landing instruction. The control system 207 may then determine the current location and/or velocity of the aircraft, and then control the operation of the propulsion system 201 based on the flight instruction. During the operation of the aircraft, the control system 207 may be configurable to continuously monitor the operational states of the propulsion system 201 in view of the flight instruction.

### Damping Unit

As illustrated in FIGS. 2A-2D, a damping unit 250 can also be included as a part of the tilting mechanism or as an addition to the tilting mechanism. As mentioned above, FIG. 2A illustrates an example of the propulsion system 201 in a vertical flight configuration. FIG. 2B illustrates an example of the propulsion system 201 in a first intermediary tilt configuration. FIG. 2C illustrates an example of the propulsion system 201 in a second intermediary tilt configuration. FIG. 2D illustrates an example of the propulsion system 201 in a forward flight configuration. In each of these illustrations, the damping unit 250 can be coupled to the propulsion system 201, and the damping unit 250 may be in a corresponding state of extension or retraction due to the tilt configuration of the propulsion system 201.

The damping unit 250 can be a device configured to provide a damping force. The damping unit 250 can absorb and dissipate kinetic energy. The damping unit 250 can be a mechanical device, a hydraulic device, a pneumatic device, an electromagnetic device, and/or any other suitable device configured to resist motion. As examples, the damping unit 250 can include one or more springs, cushions, pneumatic shock absorbers, hydraulic shock absorbers, dashpots, and/or the like.

In some embodiments, the damping unit 250 can take the form of a dashpot. A dashpot can use viscous friction to resist motion. For example, a dashpot can include a cylinder with a piston immersed in a viscous fluid. An external force acting on the piston causes the piston to move through the viscous fluid. The viscous fluid provides resistance to the movement of the piston, and the piston thereby experiences a resistance force opposite the direction of the external force.

According to embodiments, the damping unit 250 can resist motion in one direction or in two directions. The second direction may be opposite the first direction. In some embodiments, the damping unit 250 can provide a relatively greater resistance to motion in the first direction and a relatively smaller resistance to motion in the second direction. The damping unit 250 can include an elongated cylinder, rod, and/or piston. The one or more directions of resistance can be along the axis of the elongated cylinder, rod, and/or piston.

As illustrated FIGS. 2A-2D, the damping unit 250 can be coupled to the propulsion system 201. For example, the damping unit 250 can be coupled to the truss structure 235 of the propulsion system 201.

Embodiments include any suitable coupling between the damping unit 250 and the propulsion system 201. In some embodiments, a third coupler 251 can couple the damping unit 250 to the truss structure 235 of the propulsion system 201. The third coupler 251 can include one or more of a pin, bolt, spherical joint, trunnion joint, fixed bracket, pivot bracket, shackle, gimble, and/or any other suitable structural coupling and/or mounting mechanisms. In some embodiments, the third coupler 251 can incorporated into the truss structure 235 and/or otherwise a part of the truss structure 235.

According to embodiments, the damping unit 250 can be coupled to the truss structure 235 of the propulsion system 201 at a location that is higher than the coupling between the actuator 230 and the truss structure 235 of the propulsion system 201. For example, the third coupler 251 can be positioned vertically above the first coupler 233. The horizontal position of the third coupler 251 relative to the first coupler 233 may change according to the tilt configuration of the propulsion system 201, but the third coupler 251 may be positioned above the first coupler 233 for most or all tilt configurations.

The damping unit 250 can also be coupled to the support structure 206. For example, a frame element 255 may be provided within the support structure 206, and the damping unit 250 can be coupled to the frame element 255. The frame element 255 can take the form of an intermediate component, such as a bracket, or any other suitable structure for fixing a first component (e.g., the damping unit 250) to a second component (e.g., the support structure 206). In some embodiments, the frame element 255 can have a circular shape. The frame element 255 can be attached to the inner surface of the support structure 206, and can surround an internal space within the support structure 206. The frame element 255 can be positioned at a predetermined distance from a first end of the support structure 206 (e.g., the left side from the perspective shown in the illustrations).

Embodiments include any suitable coupling between the damping unit 250 and the support structure 206. In some embodiments, a fourth coupler 252 can couple the damping unit 250 to the frame element 255 of the support structure 206. The fourth coupler 252 can include one or more of a pin, bolt, spherical joint, trunnion joint, fixed bracket, pivot bracket, shackle, gimble, and/or any other suitable structural coupling and/or mounting mechanisms.

According to embodiments, the support structure 206 may surround the damping unit 250. The support structure 206 can be a hollow structure partially enclosing the damping unit 250. In the illustrations in FIGS. 2A-2D, a portion of the support structure 206 is not shown in order to reveal internal components (e.g., the actuator 230 and damping unit 250) disposed within the support structure 206. Both the actuator 230 and damping unit 250 can be provided within the same enclosure between the first end of the support structure 206 and the frame element 255. While a single damping unit 250 is illustrated, additional damping units can also be included that are coupled to the propulsion system 201 and the support structure 206.

The damping unit 250 can be configured to change length through extension and/or compression (also referred to as retraction). Due to being coupled to both the propulsion system 201 and the support structure 206 (e.g., at opposite ends of damping unit 250), the damping unit 250 can be extended and/or retracted when the propulsion system 201 is put into motion (e.g., tilting motion), as a dynamic position of the third coupler 251 may be moved closer or further from a fixed position of the fourth coupler 252. For example, when the propulsion system 201 tilts upward toward vertical, the damping unit 250 may experience a tension force which causes extension of the length of the damping unit 250. When the propulsion system 201 tilts downward toward horizontal, the damping unit 250 may experience a compression force which causes retraction or compression of the length of the damping unit 250. In some embodiments, extension and retraction of the damping unit 250 may be considered passive responses or passive movements (e.g., passive extension and/or passive retraction) of the damping unit 250, as the extension and/or retraction of the damping unit 250 may be indirectly caused by the movement of coupled objects, instead of a direct actuation of the damping unit 250.

The damping unit 250 can be configured to extend and/or retract linearly relative to its own structural body. Further, due to the coupling to the propulsion system 201, the damping unit 250 may experience a pivoting or rotational motion relative to coupling points and/or external structures. As illustrated in FIGS. 2A-2D, as the propulsion system 201 tilts, the third coupler 251 may move with the propulsion system 201, and the damping unit 250 may be caused to pivot due to the third coupler 251 moving while the fourth coupler 252 maintains a fixed position on the frame element 255 of the support structure 206. The damping unit 250 may pivot about an axis (referred to as a second axis) located at the fourth coupler 252.

The damping unit 250 may be configured to resist or oppose one or both of extension and/or compression. Additionally, the damping unit 250 may be configured to provide a damping force with a magnitude that changes in response to a speed or rate of extension and/or compression. For example, the damping force may be proportionally or exponentially related to the speed of motion (e.g., length change) of the damping unit 250. Typically, a higher speed or faster movement (e.g., extension or compression) of the damping unit 250 causes a greater (e.g., larger magnitude) damping force. As a result, a relatively slower tilt motion of the propulsion system 201 may cause a relatively smaller damping force, while a relatively faster tilt motion of the propulsion system 201 may cause a relatively larger damping force.

As illustrated FIGS. 2A-2D, the third coupler 251 and the fourth coupler 252 may have different positions than the first coupler 233 and the second coupler 234. In other words, the damping unit 250 and the actuator 230 may connect to the propulsion system 201 and the support structure 206 in different locations. Nonetheless, the damping unit 250 and the actuator 230 may each provide a structural coupling and/or a load path between the propulsion system 201 and the support structure 206.

The actuator 230 may be configured to provide a primary load path between the propulsion system 201 and the support structure 206. The actuator 230 may be configured to provide enough supportive force to modify, set, and maintain a tilt orientation of the propulsion system 201, even under large loads (e.g., tension loads and/or compression loads) caused by air resistance, gravity, thrust generated by the propulsion system 201, etc.

The damping unit 250 may be configured to provide a secondary load path (also referred to as a backup or redundant load path) between the propulsion system 201 and the support structure 206. The damping unit 250 may be configured to provide sufficient damping force to resist rapid and/or sudden tilt movements of the propulsion system 201, which can include large loads in the form of tension and/or compression. The damping unit 250 can have any suitable size (e.g., length, circumference, width), materials, and/or other configurations to provide a sufficient force under predefined conditions (e.g., a certain speed of tilt movement).

According to embodiments, the damping unit 250 may be configured to provide a damping force (e.g., tension or compression) between the propulsion system 201 and the support structure 206 only when there is relative movement between the propulsion system 201 and the support structure 206 causing the damping unit 250 to passively extend or passively retract. For example, when a tilt configuration (also referred to as tilt position) of the propulsion system 201 is set and not currently changing, the damping unit 250 may not experience any extension or retraction, and therefore may not provide any damping force. In contrast, the actuator 230 may be providing structural support with sufficient force to maintain a set tilt configuration of the propulsion system 201.

When the actuator 230 is actuating to cause a change in tilt configuration of the propulsion system 201, the damping unit 250 may then experience extension or retraction, and therefore may provide a damping force. The damping unit 250 may provide a force that opposes the movement of the propulsion system 201. In some embodiments, this may cause an extra load on the actuator 230 as it provides extra force to overcome the damping force. In other words, the actuator 230 of the primary load path may drive against the damping unit 250 of the secondary load path. Accordingly, the primary load path and the secondary load path may apply tilting force to the propulsion system 201 simultaneously and/or in opposite directions. However, according to embodiments, the actuator 230 may be controlled to change the tilt configuration slowly and gradually. As a result, the actuating can be controlled to cause only a relatively small damping force that is not difficult to overcome and/or lesser than other external forces (e.g., as caused by air resistance, gravity, and/or thrust).

The primary load path and the secondary load path may be considered parallel load paths. Parallel load paths may operate in parallel with one another. Operating in parallel can include providing two separate paths or branches of bearing load and/or providing force between the same set of components (e.g., the propulsion system 201 and the support structure 206). The primary load path and the secondary load path can operate in parallel even if the actuator 230 and damping unit 250 are not geometrically parallel (e.g., aligned or level with one another in three-dimensional space).

According to embodiments, the secondary load path may be configured to fully activate and bear some or all of the load between the propulsion system 201 and the support structure 206 upon failure of the primary load path. If the actuator 230 fails and no longer provides supportive force between the propulsion system 201 and the support structure 206, the propulsion system 201 may experience rapid movement. This rapid movement can cause a corresponding rapid extension and/or retraction of the damping unit 250, which in turn can cause the damping unit 250 to produce a large resisting force. The damping unit 250 can thereby provide a secondary load path with sufficient force to slow the tilting movement of a propulsion system 201 without a primary load path.

In the event of a mechanical failure of the actuator 230, one or more or parts thereof may be broken. For example, breaks in any of the actuating component 231, translating component 232, and/or first coupler 233 may disable the primary load path. Without the primary load path providing structural stability and support to the propulsion system 201, many movements of the propulsion system 201 are possible, depending upon a number of variables. For example, if the aircraft is in a forward flight configuration at cruising speed and the propulsion system 201 is providing forward thrust, the propulsion system 201 may exert a large force to drive the aircraft forward. The actuator 230 may bear this load by translating the force into the support structure 206 (and the rest of the aircraft). The actuator 230 may provide a strong stabilizing tension force between the propulsion system 201 and the support structure 206 that effectively pulls the support structure 206 (and remainder of the aircraft) forward in space along with the propulsion system 201. In the event of a failure of the actuator 230, the tension force provided by the primary load path may no longer be available. As a result, the propulsion system 201 may drive itself forward with its own generated forward thrust. With the revolute joint 260 still in place and connecting the propulsion system 201 to the support structure 206, the propulsion system 201 may thrust itself into a sudden and/or strong upward tilting motion about the revolute joint 260. If there is no backup load path (e.g., provided by a damping unit), this motion may be fast and/or strong enough to damage the revolute joint 260 and/or break the revolute joint 260, potentially leading to detachment of the propulsion system 201 from the aircraft. Due the potential high-speed nature of such events, it may not be possible to de-power the propulsion system 201 to stop thrust generation before movements and possible damage have already occurred.

In another example, if the actuator 230 fails when the propulsion system 201 is de-powered, the propulsion system 201 may suddenly drop from a vertical tilt configuration to a forward flight configuration. If there is no backup load path to control or mitigate this motion, this motion may also potentially damage the revolute joint 260, components of the propulsion system 201, and/or components of the support structure 206. Other uncontrolled movements of the propulsion system 201 are also possible in the event of a failure of the actuator 230.

The damping unit 250 can be configured to slow down any otherwise uncontrolled movements of the propulsion system 201 in the event of a failure of the actuator 230. In some embodiments, the damping unit 250 can be a passively responsive mechanism that is always engaged and therefore automatically and immediately responds to sudden movements of the propulsion system 201 without needing direct actuation or other control instructions from a control system. A control system may deactivate the propulsion system 201 soon after the failure event.

The damping unit 250 may not completely stop movements of the propulsion system 201 (e.g., tilting up due to thrust, or tilting down due to gravity). However, the damping unit 250 may be configured to extract energy from movements of the propulsion system 201 so that the revolute joint 260, components of the propulsion system 201, and/or components of the support structure 206 do not experience detachment or other damage. As mentioned above, the damping unit 250 may provide a greater damping force in response to a faster tilt movement of the propulsion system 201 as this can cause a greater speed of extension or compression of the damping unit 250. Accordingly, the damping unit 250 can provide a variable and sufficient force to resist a sudden and variable tilting force so that tilting of the propulsion system 201 occurs below a threshold speed or otherwise at an acceptable level.

Embodiments are primarily described herein with respect to a tilting propulsion system with an actuator configured to tilt the tilting propulsion system. Embodiments can also apply to any other suitable type of movable element and/or actuator used in any other suitable context. For example, embodiments can apply to other movable elements and corresponding actuators on an aircraft and/or actuators in other types of vehicles and any other suitable mechanical application. Examples of other movable elements on an aircraft that utilize an actuator, and to which embodiments can apply, include an aileron, elevator, rudder, spoiler, flap, slat, airbrake, and/or any other suitable control element or lift surface used to maneuver and control the movement, speed, and/or altitude of an aircraft. Such movable elements may similarly be driven by an actuator that actuates between an extended position and a retracted position and thereby causes a motion of the moveable element. Additionally, a damping unit can be coupled to such movable elements as a secondary load path that supports the movable element in case of failure of the actuator or other primary load path.

### Tunable Damping Unit

As discussed above, the damping unit 250 may be configured to provide a damping force in response to extension and/or compression. The magnitude of the damping force may change in response to a rate of extension and/or compression. For example, a higher speed of extension and/order compression of the damping unit 250 may cause a greater damping force.

According to embodiments, the damping unit 250 can have damping mode. A damping mode can characterize a level of damping provided by the damping unit 250. The damping mode can include relationship between damping force and a rate of extension and/or compression. The relationship can be proportional. For a given damping mode, a predefined range of damping forces can be associated with a predefined range of extension speeds and/or compression speeds. In some embodiments, the damping mode can include a ratio of the damping force to the velocity of extension and/or compression of the damping unit 250. A higher damping mode (also referred to as a greater or stronger damping mode) can produce a greater damping force for a given speed of extension and/or compression relative to a damping force produced by a lower damping mode. Similarly, a higher damping mode can have a higher ratio of damping force to the velocity of extension and/or compression relative to a lower damping mode. The damping mode may be produced by a structural configuration (e.g., a piston size, a cylinder size, a ratio of piston to cylinder sizes, a piston shape), a viscosity of fluid, and/or any other suitable characteristics of the damping unit 250. The damping mode can also be referred to as a damping coefficient (“c”), damping level, resistance level, damping setting, damping characteristic, or damping configuration.

In some embodiments, the damping unit 250 may have a predefined static damping mode. Accordingly, while the damping force may be a dynamic force based on a dynamic speed of extension and/or compression of the damping unit 250, the damping mode may be a static characteristic of the damping unit 250.

According to other embodiments, the damping unit 250 may have a dynamic and/or tunable damping mode. The damping unit 250 may be controllable (e.g., via one or more controllable parameters) to change the damping mode. A damping unit with a tunable damping mode can be referred to as a tunable damping unit, an adjustable damping unit, or a dynamic damping unit. A tunable damping unit can be tuned (also referred to as adjusted or set) to one or more damping modes. In some embodiments, a tunable damping unit can be tuned to any damping mode within a predefined range of damping modes. A tunable damping unit may have a fast response time and/or low latency time, allowing for immediate adjustments (e.g., on the order of milliseconds) in response to events.

Embodiments include any suitable form of tunable damping unit. For example, a tunable damping unit can take the form of magnetorheological (MR) damping unit. An MR damping unit (also referred to as an MR shock absorber) may be a damping unit comprising magnetorheological fluid. The magnetorheological fluid can be controlled by a magnetic field, which may be produced by an electromagnet. Fluid viscosity increases within the MR damping unit as the magnetic field intensity increases (e.g., due to suspended metal particles in the fluid becoming aligned with field lines). Accordingly, varying the amount of power supplied to the electromagnet can cause variation in the magnetic field intensity, which can in turn cause variations in the characteristics (e.g., viscosity) of the magnetorheological fluid, thereby adjusting the damping mode of the MR damping unit.

An MR damping unit may include a housing, a rod, a bearing retainer, MR fluid regions, an MR piston assembly, a diaphragm, a gas charge, power supply wires, and/or any other suitable components. An MR piston assembly can include coil windings, an annular orifice, magnetic flux regions, among other components. An MR damping unit may have a latency that is less than a predetermined threshold (e.g., 20 milliseconds) when adjusting from a minimum damping mode to a maximum damping mode. As an example, an MR damping unit may be able to provide a damping force of about 30 kN when about 3 A current is supplied at about 15V (e.g., about 45 W power consumption)

Other examples of a mechanisms that can provide a tunable damping mode include friction-based systems such as dynamic brakes, and electromagnetic-based systems such as a solenoid that produces a dynamic force on a piston.

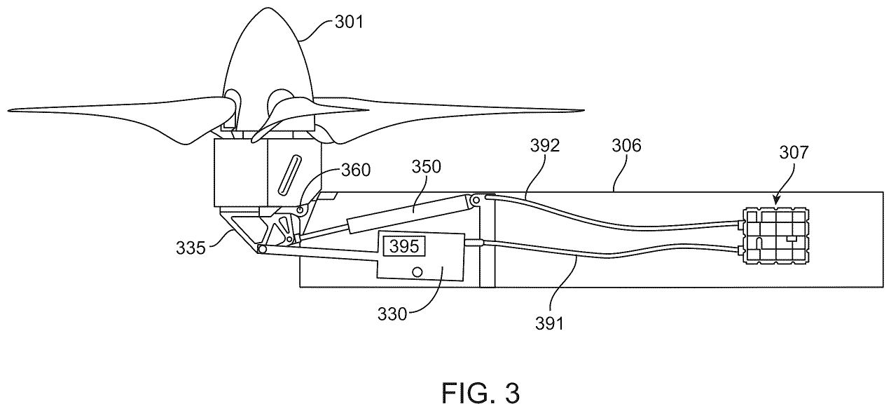

FIG. 3 illustrates an example of a propulsion system 301 with a tunable damping unit 350, according to embodiments. The propulsion system 301 illustrated in FIG. 3 can be the same as or similar to the propulsion system 201 illustrated in FIGS. 2A-2D. For example, similar to the propulsion system 201 illustrated in FIGS. 2A-2D, the propulsion system 301 illustrated in FIG. 3 can include an actuator 330, a support structure 306, a revolute joint 360, a truss structure 335, any suitable couplers, etc. However, the propulsion system 301 illustrated in FIG. 3 can include a tunable damping unit with a tunable damping mode instead of a damping unit with a static damping mode.

As illustrated in FIG. 3, an actuator 330 and a tunable damping unit 350 can each be positioned and coupled to the propulsion system 301 similarly to the configurations discussed above with respect to FIGS. 2A-2D.

A control system 307, which can be similar to or the same as the control system 207 in FIGS. 2A-2D, can be in operative communication with the actuator 330. For example, the control system 307 can operate the actuator 330 via an actuator control line 391. The actuator control line 391 can be an electrical wiring interconnect system (EWIS) wire electrically coupling the control system 307 and the actuator 330.

One or more sensors can be coupled to the actuator 330 and/or incorporated into the actuator 330, such as the sensor 395. The sensor 395 can be a position sensor, a load sensor, and/or any other suitable type of sensor. The sensor 395 can provide information to the control system 307 about one or more conditions at the actuator 330, such as a current position setting and/or load measurement.

The control system 307 can also be in operative communication with the tunable damping unit 350. For example, the control system 307 can operate the tunable damping unit 350 through a damping unit control line 392. The damping unit control line 392 can be an electrical wiring interconnect system (EWIS) wire electrically coupling the control system 307 and the actuator 330. The damping mode can be increased or decreased in response to control signals from the control system 307.

### Triggers for Changing Damping Mode

The control system 307 may operate the tunable damping unit 350 to change the damping mode in response to an event or at any other suitable time. The control system 307 can determine whether to increase and/or decrease the damping mode based on a type of event or conditions associated with the event. An event can include any suitable activity, action, plan, or changing in conditions associated with a change in preferred damping mode. An example of an event is a flight instruction or control instruction, such as instructions or operations to tilt a propulsion system 301, and/or instructions or operations to modify or otherwise produce propulsion system 301 thrust (e.g., to increase aircraft speed, decrease aircraft speed, provide additional vertical lift). Another example of an event is a detection of a change in weather conditions or flight conditions, such as a change in wind direction or speed, a change in turbulence, a change in aircraft speed (e.g., exceeding or falling below a predetermined threshold), and/or a change in direction of travel. Another example of an event is a change in component conditions, such as a change in net forces on the aircraft or a propulsion system 301 (e.g., a combination of gravity, thrust, drag, damping forces, etc.), a change in load on an actuator 330 (e.g., exceeding a predetermined threshold), and/or a failure of an actuator 330. An event can be identified by a control system 307 based on data from one or more sensors, flight plans, flight instructions, etc. The control system 307 may be configured to proactively operate the tunable damping unit 350 so that the damping mode is changed before a control instruction (e.g., to tilt a propulsion system 301) is executed. Additionally or alternatively, the control system 307 may be configured to reactively operate the tunable damping unit 350 in response to a detected change in conditions. Several examples of events are discussed in detail below.

As mentioned above, an example of an event that can trigger the control system 307 to adjust the tunable damping unit 350 is a failure of the actuator 330. As discussed above, if the actuator 330 fails, the propulsion system 301 may experience an uncontrolled and/or rapid change in tilt angle. The control system 307 may determine when a failure event occurs in any suitable manner. As examples, the control system 307 may determine that the current load on the actuator 330 is zero, that communications with the actuator 330 have been disconnected, that the tilt position is changing rapidly, that the intended or instructed tilt position does not match an actual measured tilt position (e.g., as reported by the sensor 395) within a predetermined threshold (e.g., ⅓ degree, ½ degree, 1 degree, 2 degrees, 5 degrees, and/or any other suitable predetermined range of tilt angle matching error). In response to determining an actuator 330 failure event, the control system 307 may determine to operate the tunable damping unit 350 to have a higher damping mode. A higher damping mode that damps more strongly can beneficially slow the movement of the tilting propulsion system 301 adjusting the tilt angle at any position between the vertical flight configuration and the forward flight configuration more quickly and/or effectively, and thereby reduce the likelihood of damage. Thus, the control system 307 can increase the damping mode of the tunable damping unit 350 in response to sensor data indicating a failure event.

Another example of events that can trigger the control system 307 to adjust the tunable damping unit 350 is a flight condition of high-speed travel (e.g., exceeding a predetermined speed threshold) or high thrust output (e.g., exceeding a predetermined thrust threshold). High-speed travel and/or high thrust power can cause vibrations that increase vibratory loads on the actuator 330. In response to such an event, the control system 307 can determine operate the tunable damping unit 350 to increase resistance in order to receive, absorb, and dampen the vibrations and reduce the vibratory loads on the actuator 330. This can beneficially reduce wear on the actuator 330 and, for example, increase lifespan of internal bearings of the actuator 330.

At lower speeds (e.g., below the same predetermined threshold speed or a lower predetermined threshold speed), lower thrusts, and/or at other suitable times, the tunable damping unit 350 can be operated to have a lower damping mode in order to reduce potential parasitic damping loads on the actuator 330. This can eliminate any need for an oversized actuator that can tolerate parasitic damping.

During tilting operations when the actuator 330 is functioning properly, the damping mode of the damping unit 350 can be dynamically selected to mitigate loads and wear on the actuator 330 and/or conserve power. Depending on the current circumstances, either a relatively higher damping mode or a relatively lower damping mode can beneficially reduce loads on the actuator 330. Accordingly, different circumstances or events (e.g., changes in circumstances) can affect whether the control system 307 determines to increase the damping mode or decrease the damping mode.

For example, under certain conditions, the damping unit 350 may oppose the actuator 330 and thereby increase the load on the actuator 330. In other words, a second force (e.g., a second rotational force) produced by the damping unit 350 may oppose a first force (e.g., a first rotational force) produced by the actuator 330. The forces from the damping unit 350 and the actuator 330 may be opposed when the actuator's force is applied in a direction that matches or supports a current tilting movement direction of the propulsion system 301. In the case of an event or circumstance where the damping unit 350 opposes the actuator 330, it can be beneficial to reduce the damping mode of the damping unit 350 (and the control system 307 may determine to reduce the damping mode) to reduce resistance applied to the actuator 330, and thereby mitigate the load and wear on the actuator 330 and/or allow faster tilting speeds without experiencing large increases in opposing damping forces.

Whether the damping unit's damping force is opposed to (or aligned with) the actuator's force on the propulsion system 301 may be based on the direction of tilting during a tilting event, the net combination of other rotational forces (e.g., gravity, drag, thrust) acting on the propulsion system 301, and/or any other suitable factors. Accordingly, the damping unit 350 may oppose the actuator 330 under various circumstances or during various events. For example, when the aircraft is on the ground with little or no wind and the propulsion system 301 is producing little or no thrust, the largest rotational force on the tilting propulsion system 301 may be due to gravity. In this situation, in the event of operating the actuator 330 to tilt the propulsion system 301 upward from a forward flight configuration to a vertical flight configuration, the actuator 330 may provide an extending pressure force (e.g., in the same direction as the tilting direction) which may be opposed by the damping unit 350 (e.g., thereby increasing the pressure load on the actuator 330). As another example, during forward cruising flight, forces from drag and/or thrust produced by the propulsion system 301 may be greater than the force from gravity, and may bias the tilting propulsion system 301 to tilting upward toward the vertical flight configuration. In the event where the tilting propulsion system 301 is operated to move from a vertical flight configuration to a forward flight configuration, the actuator 330 may provide a retracting tension force (e.g., in the same direction as the tilting direction) which may be opposed by the damping unit 350 (e.g., thereby increasing the tension load on the actuator 330).

Under other conditions, the damping unit 350 may be aligned with the actuator 330 and thereby reduce the load on the actuator 330 or otherwise support the actuator 330. In other words, a second force (e.g., a second rotational force) produced by the damping unit 350 may be aligned with or in the same direction as a first force (e.g., a first rotational force) produced by the actuator 330. The forces from the damping unit 350 and the actuator 330 may be aligned when the actuator's force is applied in a direction that opposes or resists a current tilting movement direction of the propulsion system 301, as the damping unit 350 typically opposes tilting movements as well. In the case of an event or circumstance where the damping unit 350 supports or is aligned with the actuator 330, it can be beneficial to increase the damping mode of the damping unit 350 (and the control system 307 may determine to increase the damping mode) to further support the actuator 330, and thereby mitigate the load and wear on the actuator 330.

The damping unit 350 may support or be aligned with the actuator 330 under various circumstances or during various events. For example, as discussed above, when the aircraft is on the ground with little or no wind and the propulsion system 301 is producing little or no thrust, the largest rotational force on the tilting propulsion system 301 may be due to gravity, which may thereby cause a net bias toward tilting downward. In this situation, when the actuator 330 is operated to tilt the propulsion system 301 upward from a vertical flight configuration to a forward flight configuration, the actuator 330 may provide a controlled reduction of pressure force that allows the tilting propulsion system 301 to controllably tilt downward due to gravity. In this case, the actuator's pressure force is opposed to the direction of tilting movement, and therefore aligned with the damping force produced by the damping unit 350 during tilting motion. As another example, as mentioned above, during forward cruising flight, forces from drag and/or thrust produced by the propulsion system 301 may be greater than the force from gravity, and may produce a net bias of tilting upward. In the forward flight configuration, the actuator 330 may provide a tension force to restrain the tilting propulsion system 301 from tilting upward. In the event where the tilting propulsion system 301 is operated to move from a forward flight configuration to a vertical flight configuration, the actuator 330 may provide a controlled reduction of the tension force that allows the tilting propulsion system 301 to controllably tilt upward due to the drag and/or thrust. In this case, the actuator's tension force is opposed to the direction of tilting movement, and therefore aligned with the damping force produced by the damping unit 350 during tilting motion.

In some embodiments, instead of adjusting the damping mode for any change in conditions, the control system 307 may monitor the actuator 330 for large loads. If the control system 307 determines that an operation of the actuator 330 to tilt the propulsion system 301 is causing a load on the actuator 330 that is larger than a predetermined threshold load, the control system 307 may operate the tunable damping unit 350 to so that the damping mode is lowered (e.g., in an event where the tunable damping unit 350 is opposing the actuator 330). The damping mode can be lowered further than a default low-damping mode. The control system 307 may determine the load size based on power consumption by the actuator 330, a pressure sensor, a heat output sensor, and/or any other suitable sensors or system monitoring equipment. The control system 307 can thereby adjust the tunable damping unit 350 in response to sensor data detecting a load condition of the actuator 330.

Another example of an event that can trigger the control system 307 to adjust the tunable damping unit 350 is the completion of a tilting motion. The tunable damping unit 350 can be operated to return to a default or standby damping mode if the tunable damping unit 350 had been adjusted for a temporary tilting motion or flight condition. This can include raising the damping mode back to a default level and/or lowering the damping mode back to a default level.

### Method for Operating Tunable Damping Unit

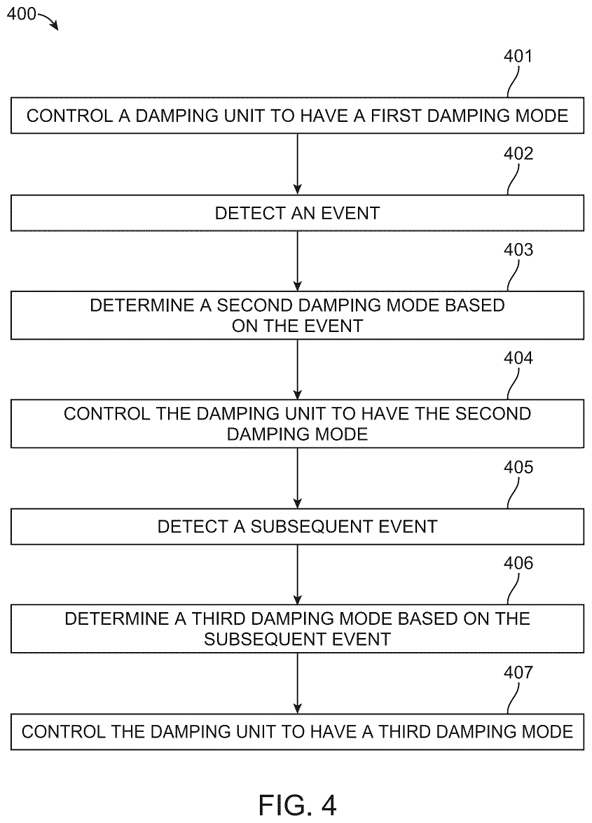

A method 400 for operating a tunable damping unit with a variable damping mode can be described with respect to FIG. 4.

At step 401, the control system can operate the tunable damping unit to be set to a first damping mode.

At step 402, the control system can detect an event. For example, the event may be a failure of the actuator, and the control system can determine that the actuator has failed (e.g., based on information received from one or more sensors). As another example, the event may be a change in one or more conditions (e.g. a load on the actuator exceeding a predetermined threshold), and the control system can identify the change in one or more conditions based on information received from one or more sensors. As another example, the event may be a flight instruction (e.g. tilt a propulsion system), received and/or determined by the control system. Additional examples of events are discussed above.

At step 403, the control system can determine a second damping mode based on the event. For example, depending on the type of event, the control system may determine a second damping mode that is a higher damping mode that produces greater damping forces than the first damping mode. Embodiments may increase the damping mode in response to determining that the actuator has failed, determining that a load on the actuator has exceeded a predetermined threshold while damping forces applied to the propulsion system are in the same direction as (e.g., and thereby complement) an actuator force applied to the propulsion system, determining that a flight instruction will cause a load on the actuator to exceed a predetermined threshold while damping forces applied to the propulsion system are in the same direction as (e.g., and thereby complement) an actuator force applied to the propulsion system, determining that a load on the actuator due to vibrations from high speed travel has exceeded a predetermined threshold, and/or in response to any other suitable event or conditions.

As another example, depending on characteristics of the event, the control system may determine a second damping mode that is a lower damping mode that produces lesser damping forces than the first damping mode. Embodiments may decrease the damping mode in response to determining that a load on the actuator has exceeded a predetermined threshold while damping forces applied to the propulsion system are in the opposite direction as (e.g., and thereby oppose) an actuator force applied to the propulsion system, determining that a flight instruction will cause a load on the actuator to exceed a predetermined threshold while damping forces applied to the propulsion system are in the opposite direction as forces applied to the propulsion system, and/or in response to any other suitable event or conditions.

At step 404, the control system can, in response to the event, operate the tunable damping unit to be set at the second damping mode.

At step 405, the control system can detect a subsequent event. For example, the control system may determine that a load on the actuator has decreased below the predetermined threshold.

At step 406, the control system can determine a third damping mode based on the subsequent event. The third damping mode may be higher or lower than the second damping mode and/or first damping mode. In some embodiments, the third damping mode may be the same as the first damping mode. For example, the control system may the first damping mode may be a default damping mode that is utilized outside of events.

At step 407, the control system can, in response to the subsequent event, operate the tunable damping unit to be set at the third damping mode (e.g., which may be a return to the first damping mode.

According to embodiments, the control system can continue to detect additional events, determine additional damping modes, and/or control the damping unit to have a new damping mode any suitable number of times during a flight.

### Performance of Example Damping Modes

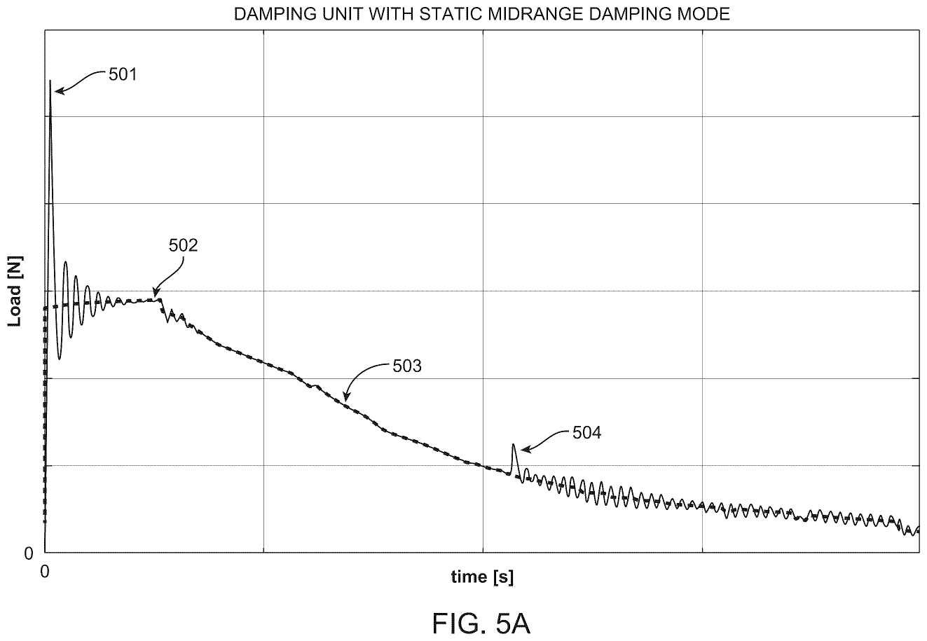

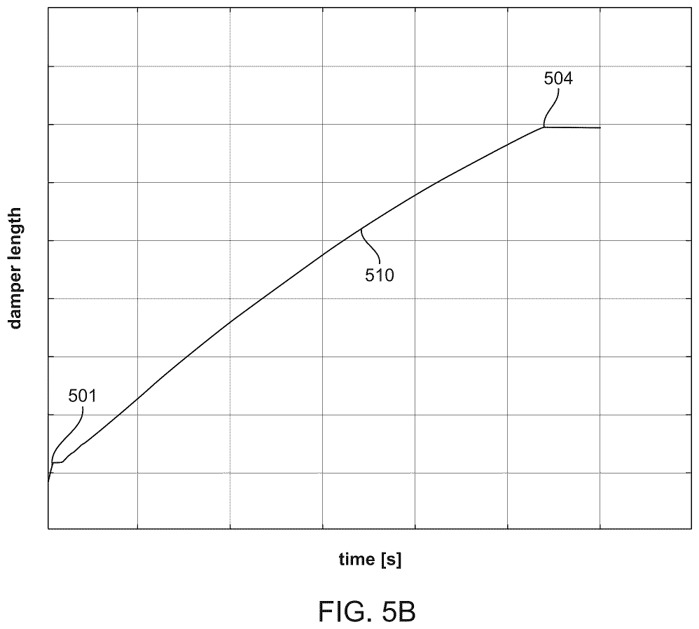

FIG. 5A illustrates damping unit loads (e.g., in Newtons) experienced during an actuator failure event, according to embodiments. Applied load of the propulsion system is represented by the dotted line, while a tensile load on the damping unit (e.g., an actual load experienced by the damping unit during operation) is represented by the solid line. The plot relates to a damping unit with static (e.g., non-tunable) damping mode in a middle range of practical damping modes, according to embodiments.

As shown in FIG. 5A at time 501, a large impulse (e.g., in the tensile load) is experienced when the damping unit first engages in response to failure of the actuator. This impulse load may be greater than the static applied load of the propulsion system. The impulse load may occur due to the sudden engagement of the damping unit after the load was previously being handled by the actuator, and due to the propulsion system having gained some amount of tilting motion/speed. Also, the damping unit may have a dynamic response and a delay (e.g., on the order of milliseconds or less than a second) in receiving the load as caused by spring configurations, time needed for fluid transfer, air bubbles that can create a “dead zone” where damping force is not yet applied, etc. During the delay, the propulsion system may gather tilting velocity, which can then cause an abrupt load on the damping unit when it first engages. According to embodiments, the damping unit and/or other associated hardware may be configured to withstand such an impulse. However, this may involve including extra and/or heavier materials to strengthen the components.

At time 502, as the damping unit settles shortly after engagement, the tensile load stabilizes to match the applied load.

At time 503, the applied load and tensile load both decrease as the tilting speed of the propulsion system decreases.

At time 504, the propulsion system and/or damping unit may reach the end of a travel range in either direction. At the end of the travel range, an impact may occur that may cause vibrations and oscillating loads as shown in the tensile load after time 504.

FIG. 5B illustrates extension or length 510 of a damping unit as a function of time (e.g., on the order of a less than a second, a second, or a few seconds) during an actuator failure event. The plot may relate to the same failure event depicted in FIG. 5A. After the damping unit is engaged at time 501, the length 510 may increase until it reaches a maximum stroke or until the propulsion system reaches a maximum tilt angle (e.g., about 90 degrees) at time 504. As this happens, the damping unit length 510 may increase until it reaches a maximum length.

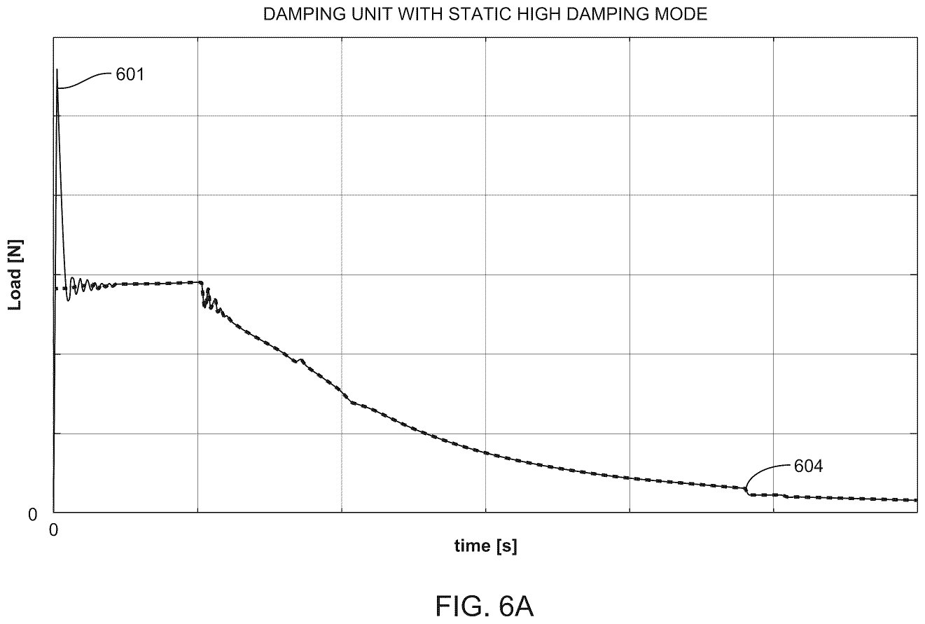

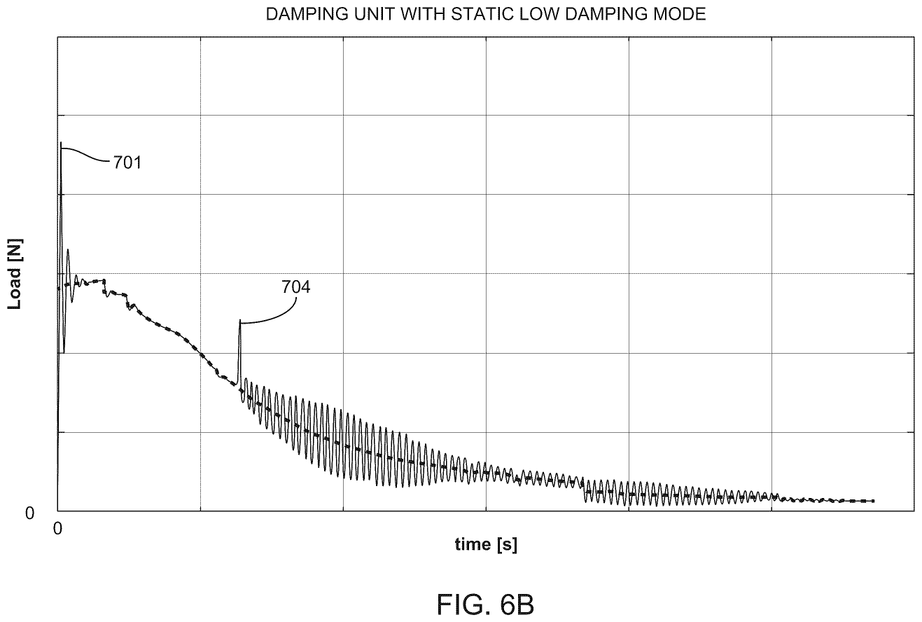

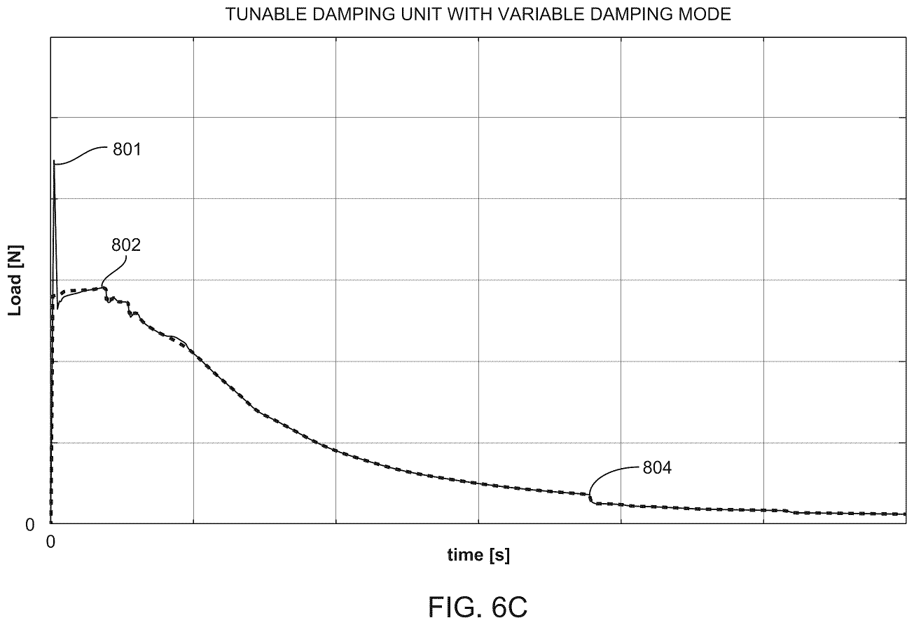

FIG. 6A illustrates damping unit loads experienced during an actuator failure event for a damping unit with static damping mode that is a higher or stronger than the damping mode of FIG. 5A, according to embodiments. As shown, the higher damping mode causes a greater initial impulse load than in FIG. 5A, due to a greater resistance impulse upon the initial engagement at time 601. However, the impact at the end of the damping and/or tilting travel range at time 604 is reduced as the greater damping mode more effectively slows the tilting speed of the propulsion system before reaching the end of the travel range. As a result, oscillating loads can be reduced and/or eliminated at and after time 604.

FIG. 6B illustrates damping unit loads experienced during an actuator failure event for a damping unit with static damping mode that is a lower or weaker than the damping mode of FIG. 5A, according to embodiments. As shown, the lower damping mode causes a lower initial impulse load than in FIG. 5A (and FIG. 6A), due to a lower resistance impulse upon the initial engagement at time 701. However, the impact at the end of the travel range at time 704, and resulting oscillating loads, may be increased as the lower damping mode is less effective for slowing the tilting speed of the propulsion system and therefore the propulsion system may reach the end of its travel range with more momentum remaining.

FIG. 6C illustrates damping unit loads experienced during an actuator failure event for a tunable damping unit, according to embodiments. Initially, the tunable damping unit may be controlled to have a low damping mode (e.g., similar to FIG. 6A or lower). As a result, the initial engagement impulse load at time 801 is beneficially reduced. Lower peak loading can enable the user of smaller and/or more lightweight components that reduce total aircraft weight, as they may not need to be configured to withstand a large impulse. As shown, the impulse load is lesser than shown in each of FIG. 5A, FIG. 6A, and FIG. 6B, as the tunable damping unit can be allowed to be set at a lower damping mode than any static damping unit with a static damping mode. A brief lag before the damping mode is rapidly increased can beneficially soften the initial engagement impulse. The tunable damping unit can then be operated to rapidly increase the damping mode (e.g., to be similar to or higher than FIG. 6B) at, before, or around time 802. As a result, tilting of the propulsion system can be effectively slowed such that there is little or no impact when the propulsion system comes to rest at the end of its tiltable range (and/or the damping unit reaches its end stop) at time 804. As shown, there may be little to no oscillating loads at and after time 804. Accordingly, the tunable damping unit can achieve the benefits of both a static damping unit with a high damping mode and a static damping unit with a low damping mode, while also avoiding the downsides of each. The tunable damping unit can achieve a tensile load that closely matches the applied load throughout various phases of an actuator failure event. The tunable damping unit can achieve these benefits by providing a dynamic damping mode within the timeframe of an actuator failure event. Additionally, the tunable damping unit can be dynamically tuned to lower or higher damping modes than a static damping unit, as a static damping unit may typically be constrained to a middle-range damping mode that is strong enough to handle failure modes while also not causing too much additional loading during normal operation.

### Flight Process

According to various embodiments, a control system may control flight of an aircraft configured for vertical takeoff and landing.

An aircraft may be in a stationary position on the ground. For example, the aircraft may be parked at a charging station for charging the batteries. Alternatively, the aircraft may be parked at a location awaiting to receive cargo or passengers.

The flight control system of the aircraft may receive a flight plan (e.g., from the autopilot, a pilot or a remote controller pilot) to arrive at a predetermined destination. The flight plan may include an instruction to takeoff from the ground. The flight control system may control one or more of the propulsion systems to activate. For example, the thrust-producing components of the aircraft may be deactivated or in a standby mode. The flight control system may power up the propulsion systems from a deactivated mode so that they are ready to generate vertical lift.

The control system may operate a set of one or more propulsion systems coupled to the aircraft. Each of the first set of one or more propulsion systems may have a tiltable orientation currently set to a vertical flight configuration.

For example, the flight control system may initiate a takeoff sequence to lift the aircraft off of the ground. The flight control system may operate the set of one or more propulsion systems to provide vertical thrust so that the aircraft leaves the ground. The flight control system may continue operating the first set of one or more propulsion systems in this manner until a certain time has passed or a certain height is reached (e.g., a safe distance from a landing pad).

After a certain amount of time has passed and/or altitude gained, the flight control system may determine or receive an instruction to transition to forward flight. Before switching to the forward flight mode, the control system may check one or more of the altitude, speed and orientation of the aircraft to ensure that the parameters are within a predetermined, desirable range.

Upon determining or receiving the flight instruction to transition to forward flight, the control system may operate the set of one or more propulsion systems to tilt to a forward flight configuration from the vertical flight configuration. In some embodiments, one or more tilting propulsion systems may be operated to gradually, iteratively, and/or continuously tilt from a vertical flight configuration to a forward flight configuration. When the tilting propulsion systems are set to one or more intermediary tilt angles, the thrust can be provided at an angle with a partial vertical component and a partial horizontal component. As the tilting propulsion systems tilt through one or more intermediary tilt angles, the horizontal thrust component increases and the vertical thrust component decreases. In some embodiments, a tilting propulsion system may be operated to tilt at or below a predefined speed that causes less than a predefined resistance from a damping unit coupled to the tilting propulsion system.

Upon approaching a landing area, the control system may determine to operate the operate the set of one or more propulsion systems to tilt from the forward flight configuration back to the vertical flight configuration. The tilting process can be performed in a gradual and controlled manner as forward velocity decreases and to guide the aircraft down to the landing area.

During the flight process, the control system may operate one or more tunable damping units (e.g., a separate damping unit for each propulsion system) in response to an event or otherwise to adapt to varying flight conditions.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

What is claimed is:

1. A system comprising:
a movable element configured to move between a first position and a second position;
an actuator coupled to the movable element and configured to move the movable element between the first position and the second position;
a tunable damping unit coupled to the movable element and configured to provide a damping force to the movable element that opposes a motion of the movable element; and
a control system configured to control the tunable damping unit, and configured to:
operate the tunable damping unit to be set at a first damping mode; and
in response to an event, operate the tunable damping unit to be set at a second damping mode.

2. The system of claim 1, wherein the event is a failure of the actuator, and wherein the control system is further configured to:
determine that the actuator has failed.

3. The system of claim 2, wherein the second damping mode is a higher damping mode that produces greater damping forces than the first damping mode.

4. The system of claim 1, wherein the event is a first event, and wherein the control system is further configured to:
in response to a subsequent event, operate the tunable damping unit to return to the first damping mode.

5. The system of claim 1, wherein the event is a change in one or more conditions, and further comprising:
one or more sensors, wherein the control system is further configured to identify the change in the one or more conditions based on information received from the one or more sensors.

6. The system of claim 1, wherein the event is an instruction to cause the actuator to move the movable element.

7. The system of claim 6, wherein the control system is further configured to:
determine that, during movement of the moveable element, the damping force will be in a same direction as an actuator force.

8. The system of claim 7, wherein the second damping mode is a higher damping mode that produces a greater damping force than the first damping mode.

9. The system of claim 6, wherein the control system is further configured to:
determine that, during movement of the moveable element, the damping force will oppose an actuator force such that the damping force causes an extra load on the actuator.

10. The system of claim 9, wherein the second damping mode is a lower damping mode that produces a lesser damping force than the first damping mode.

11. The system of claim 1, wherein the event is high speed travel above a predetermined speed threshold.

12. The system of claim 11, wherein the second damping mode is a higher damping mode that produces a greater damping force than the first damping mode.

13. The system of claim 1, wherein the event is a flight instruction, and wherein the control system is further configured to:
determine that the flight instruction when executed will cause a change in one or more conditions, and wherein operating the tunable damping unit to be set at the second damping mode occurs before the change in the one or more conditions.

14. The system of claim 13, wherein the control system is further configured to control the actuator, and configured to:
operate the actuator in response to the flight instruction.

15. The system of claim 1, wherein the first damping mode includes a first viscosity, and the first damping mode includes a second viscosity.

16. The system of claim 1, wherein the movable element is a tiltable propulsion system, and further comprising:
an aircraft including:
a fuselage;
a pair of wings coupled to opposite sides the fuselage; and
a support structure, wherein the support structure is coupled to one of the pair of wings, wherein the tiltable propulsion system is coupled to the support structure, wherein the first position is a vertical flight configuration, and the second position is a forward flight configuration.

17. A method comprising:
operating, by a control system, a tunable damping unit to be set to a first damping mode, wherein the tunable damping unit is coupled to a movable element, and the tunable damping unit is configured to provide a damping force to the movable element that opposes a motion of the movable element;
detecting, by the control system, an event; and
in response to the event, operating, by the control system, the tunable damping unit to be set at a second damping mode.

18. The method of claim 17, wherein an actuator is coupled to the movable element and configured to provide an actuating force to the movable element that moves the movable element between a first position and a second position.

19. The method of claim 18, wherein the event is a failure of the actuator, and the second damping mode is a higher damping mode that produces greater damping forces than the first damping mode.

20. The method of claim 18, further comprising:
operating, by the control system, the actuator to actuate to move the movable element; and
determining, by the control system, a load on the actuator during the motion of the movable element; and
comparing, by the control system, the load on the actuator to a predetermined threshold value, wherein the event is the load on the actuator exceeding a predetermined threshold, wherein the damping force applied to the moveable element by the tunable damping unit is in a same direction as the actuating force applied to the moveable element by the actuator, and the second damping mode is a higher damping mode that produces greater damping forces than the first damping mode.
